(19) United States
(12) Patent Application Publication
(10) Pub. No.: US 2003/0086131 A1
(43) Pub. Date: May 8, 2003

(54) Transparencies with multiple indicia

(76) Inventor: Jamison B. Slippy, Caldwell, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/008,157

(22) Filed: Nov. 7, 2001

(51) Int. Cl. H04N 1/04; H04N 1/46

(52) U.S. Cl. 358/506; 358/487

(57) ABSTRACT

Methods and apparatus for placing and utilizing two or more indicia on a single transparency. In one embodiment, a method of using a transparency comprises, generating a composite image containing two or more indicia. The composite image includes a plurality of lines, wherein each line contains a portion of one of the two or more indicia. The plurality of lines are arranged so that at least some of the lines that make up each one of the two or more indicia are interposed between the lines that make up the other of the two or more indicia. The method further includes placing the lines that form the composite image on a transparency. A mask is used to selectively display one of the two or more indicia.

### TECHNICAL FIELD

The present invention relates generally to transparencies used to convey indicia, more specifically, the present invention relates to a method of providing two or more indicia on a single transparency.

### BACKGROUND

Transparences are used to convey images or indicia to an audience. For example, an overhead transparency is used in conjunction with an overhead projection device. An overhead projection device is designed to project images onto a screen or wall from the overhead transparency. Typically, the overhead transparency is placed horizontally below a projection lens and illuminated. This projects an enlarged image on the transparency to the screen or wall. There are several different methods of depositing or printing the indicia on the transparencies. For example, one method uses a laser-induced thermal transfer of materials. Another example uses exothermic heat-producing reactions to thermally transfer inks. The cost of producing each transparency is expensive. A method of reducing the cost is desired.

For the reasons stated above, and for other reasons stated below which will become apparent to those skilled in the art upon reading and understanding the present specification, there is a need in the art for a way to reduce the overall cost of producing transparencies.

### SUMMARY

The above-mentioned problems and other problems are addressed by the present invention and will be understood by reading and studying the following specification.

In one embodiment, a method of using a transparency is disclosed. The method comprising, generating a composite image containing two or more indicia. The composite image includes a plurality of lines, wherein each line contains a portion of one of the two or more indicia. The plurality of lines are arranged so that at least some of the lines that make up each one of the two or more indicia are interposed between the lines that make up the other of the two or more indicia. The method further includes placing the lines that form the composite image on a transparency.

In another embodiment, a mask for use in projecting a selected image from a transparency having a composite image is disclosed. The composite image comprises the selected image and at least one additional image. Moreover, lines of the selected image are interposed between lines of each of the additional images. The mask comprises a sheet of material having a plurality of slots and blocking strips. The blocking strips are positioned between the slots in an alternating fashion.

In another embodiment, a computer-usable medium having computer-readable instructions stored thereon for execution by a processor to perform a method is disclosed. The method includes receiving an instruction to print two or more indicia as a composite image. The method further includes, generating the composite image. In addition, each of the two or more indicia is separated into portions and all of the portions that comprise the two or more indicia are positioned in an alternating fashion in the composite image.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is diagram of a first image;

FIG. 2 is a diagram of a second image;

FIG. 3 is a diagram of the second image imposed on the first image;

FIG. 4 is an illustration of a mask of one embodiment of the present invention;

FIG. 5 is an illustration of a mask of another embodiment;

FIG. 6 is an illustration of how the mask is aligned with the transparency of one embodiment of the present invention;

FIG. 7 is an illustration of how the mask is aligned with the transparency of another embodiment of the present invention; and

FIG. 8 is flow chart of a method to incorporate dual indicia on a single transparency in accordance with one embodiment of the present invention.

In accordance with common practice, the various described features are not drawn to scale but are drawn to emphasize specific features relevant to the present invention. Reference characters denote elements throughout the Figures and text.

### DETAILED DESCRIPTION

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

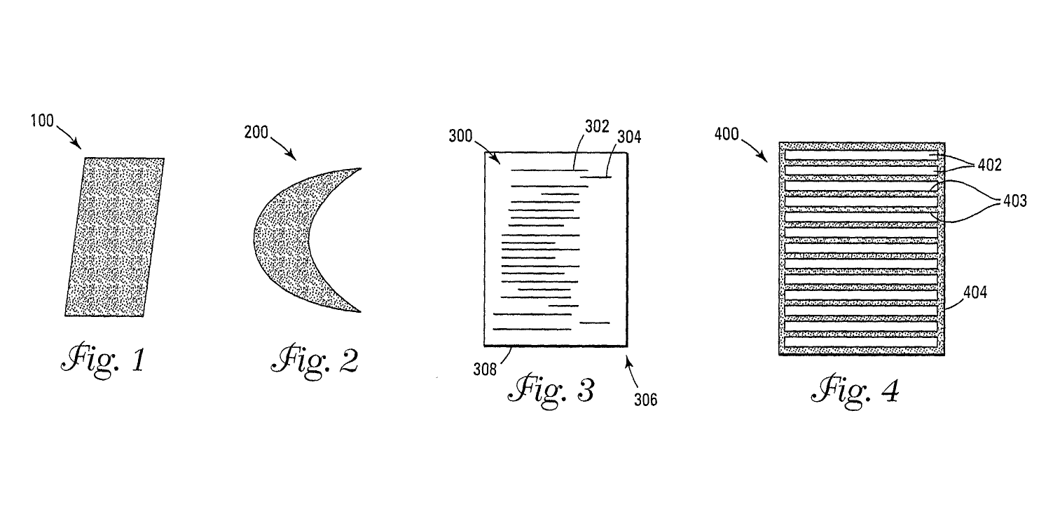

The present invention discloses a method of placing two indicia on one transparency sheet to reduce the overall cost. Referring to FIG. 1, a first image 100 or first indicia 100 is illustrated. The first image 100 represents a typical image that would be used on a first sheet of transparency. FIG. 2 illustrates a second image 200 or second indicia 200. The second image 200 represents a typical image that would be used on a second sheet of transparency. Although, the first and second images 100 and 200 are illustrated as being shapes, it will be understood in the art that they could also be text, symbols, graphical images or any other type of indicia.

Referring to FIG. 3, an illustration of a composite image 300 of the first and second images 100 and 200 on one transparency 306 is shown. As illustrated, in one embodiment, a portion of the first image 100 is printed on every other line starting with a first line 302 and a portion of the second image 200 is printed on every other line starting with the second line 304. That is, every other line alternates between the first image 100 and the second image 200. To convey one of the first or second images 100 or 200 to an audience, a mask 400 is used. An embodiment of a mask 400 is illustrated in FIG. 4. The mask 400, of this embodiment, is made up of a sheet of opaque material 404 that has a plurality of slots 402 and blocking strips 403. The slots may be referred to as viewing slots 402. The slots 402 are spaced apart from each other such that when placed over the transparency with the composite image 300, every other line of the transparency can be selectively aligned with an associated slot 402. Moreover, when every other line is aligned with an associated slot 402, the remaining lines are covered by the blocking strips 403.

When the transparency is illuminated, the mask 400 parses the composite image 300 on the transparency 306 so that only one of the images is projected. In particular, the slots 402 of the mask 400 allow one of the images 100 or 200 to be projected while the blocking strips 403 of the mask 400 cover the other of the images 100 or 200. The distance between each blocking strip 403 is predetermined so that an individual's natural ability to filter out lines created by the blocking strips 403 while still being able to perceive the image 100 or 200 aligned with the slots 402 is exploited. When the user is done projecting one of the images 100 or 200, he or she simply slides the mask 400 over the transparency 306 to selectively align the other image 100 or 200 with the slots 402 of the mask 400 thereby projecting the other image 100 or 200.

Although FIG. 3 illustrates the combining of two images 100 and 200 by alternating lines that are in horizontal rows, it will be understood in the art that the same result can be achieved by combing the images by alternating lines that are in vertical columns. That is, in one embodiment of the present invention, one of the images 100 or 200 is printed on every other column starting with a first column and another of the images is printed on every other column starting with the second column. Accordingly, with this embodiment, an associated matching mask will have alternating vertical slots and vertical blocking strips. Moreover, it will also be understood in the art that the rows or columns are not required to be straight as long as ever other line matches up with an associated slot of the mask and the remaining lines match up with an associated blocking strip of the mask. For example, in one embodiment of the present invention, the lines in horizontal rows are curved and in another embodiment lines in vertical columns are curved. In still another embodiment the lines are positioned diagonally to a bottom edge 308 of the transparency 306. As stated above, the only limitation is that the lines must be positioned so they match up with an associated mask. That is, either the mask is specifically made to match the orientation and position of the lines on the transparency or the lines on the transparency are made to match the orientation and position of the slots and blocking strips of the mask.

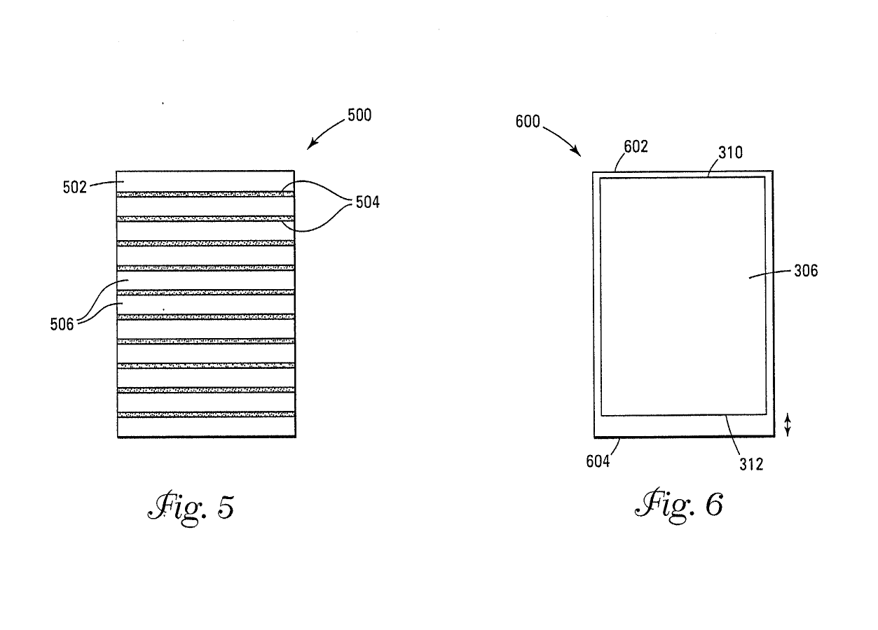

Another embodiment of a mask 500 is illustrated in FIG. 5. The mask 550 of FIG. 5 is made of a sheet 502 of transparent material. Sheet 502 has a plurality of opaque blocking strips 504 that are selectively positioned to align with every other line of the transparency 306. In between the opaque blocking strips 504 are transparent slots 506. Accordingly, when the mask 500 is properly aligned with the transparency, the opaque blocking strips 504 block out every other line of the transparency 306 while the transparent slots 506 align with the lines that make up one of the first or second images 100 or 200. In one embodiment, the sheet of transparent material is itself a transparency. In this embodiment, the user can define the mask 500 to ensure the opaque blocking strips 504 and the transparent slots 506 match up with the transparency 306 having the first and second images 100 and 200. That is, in this embodiment, the user provided instructions on the orientation and position of the lines that make up the first and second indicia 100 and 200. A processor then processes the instructions to determine the position of the opaque blocking strips 504 and transparent slots 506 to form a mask that matches the lines on the transparency defined by instructions. The mask 500 is then printed on a transparency by an imaging device. It is well known, in the art, that a processor in response to software or firmware instructions can perform such processes. In another embodiment, the user provides instructions regarding the orientation and position of the blocking strips 504 and slots 506 of the mask. A processor then processes the instructions to match the lines that make up the first and second images 100 and 200 on the transparency with the mask 500. The mask transparency 500 and the composite image 300 are then printed. Again, it is well known, in the art, that a processor in response to software or firmware instructions can perform such processes.

Referring to FIG. 6, yet another embodiment of a mask 600 is shown. FIG. 6 illustrates a mask 600 that is designed to accomplish easy alignment of the transparency 306 containing the composite image 300 to display one or the other image 100 or 200. In this embodiment, when a first end 602 of the mask 600 is aligned with a first end edge 310 of the transparency 306, the lines containing one of the first or second images 100 or 200 are aligned with the blocking strips 403 or 504 of the mask 600 while the lines that make up the other of the first and second images 100 or 200 are aligned with the slots 402 or 506. In addition, in this embodiment, when a second end 604 of the mask 600 is aligned with a second end edge 312 of the transparency 306, the first or second images 100 or 200 that was in the above example aligned with the blocking strip 403 or 504 is now aligned with the slots 402 or 506 and other of the first or second images 100 or 200 is now aligned with the blocking strips 403 or 504. Accordingly, in this embodiment, the transparency 306 can be easily slid on the mask 600 to display either the first or second images 100 or 200.

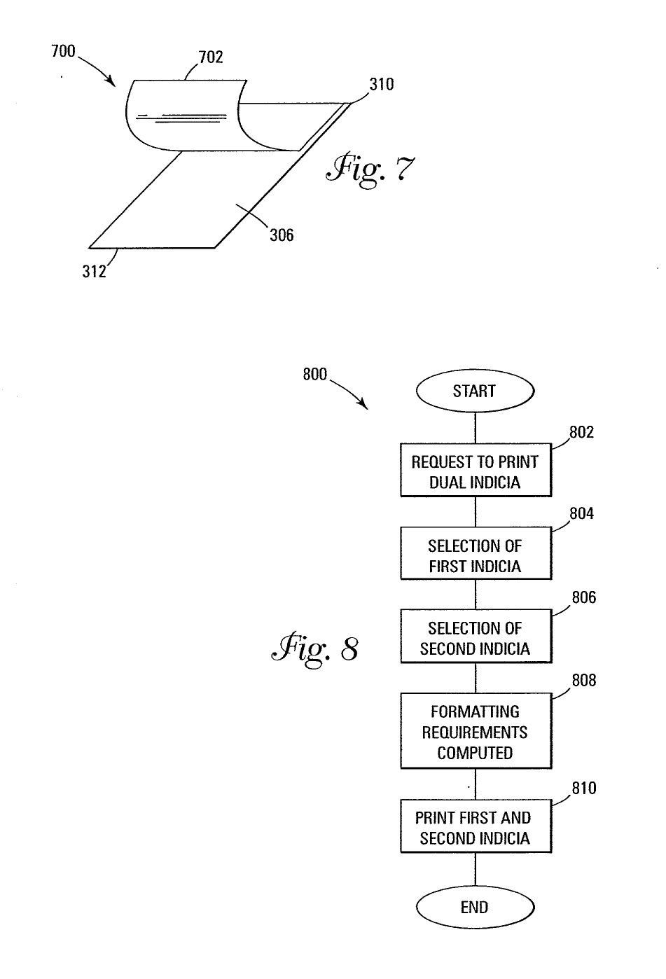

In another embodiment, a mask 700 is designed so that when a first side of the mask is positioned adjacent the transparency 306, one of the first and second images 100 or 200 is displayed and when a second side, which is flipped end to end or rotated, of the mask is positioned adjacent the transparency 306, the other of the first or second images 100 or 200 is displayed. This embodiment is illustrated in FIG. 7. In particular, in this embodiment, the lines of one of the first or second images 100 or 200 are aligned with the slots in the mask 700 while the lines of the other of first or second images 100 or 200 are aligned with the blocking strips when a first end edge 702 of the mask 700 is aligned with the first end edge 310 of the transparency. Moreover, the lines of the other of the first or second images 100 or 200 are aligned with the slots of the mask 700 and the remaining lines of the remaining first or second image 100 or 200 are aligned with the blocking strips when the first end edge 702 of the mask 700 is aligned with the second end 312 of the transparency 306. That is, the user can selectively display the first or second image 100 or 200 by simply flipping the mask 700 over end to end or rotating the mask 700 and aligning its first end edge 702 with one of the respective first or second end edges 310 or 312 of the transparency 306. It will be understood in the art that there are other ways to simplify the alignment of the blocking strips and slots with the transparency that are within the scope of the present invention and that the present invention is not limited to those discussed above.

A process 800 of printing the first 100 and the second 200 images onto a single transparency 306 is illustrated in FIG. 8. As illustrated, the user provides an instruction to print dual images on a single transparency (802). The user provides an instruction selecting a first image to print (804). The user provides an instruction selecting a second image to print (806). The lines to be printed are formatted to match a mask (808). For example the formatting may include the choosing of vertical lines, horizontal lines, diagonal lines, curved lines and the distance between the lines. The formatting parameters, i.e. shape of the lines, orientation of lines and the distance between lines, can be set by the user or preset for a specific mask. An imaging device prints the first image 100 on every other line starting with a first line 302 (810) and the second image 200 on every other line starting with a second line 304 (810).

Process 800 is accomplished with the use of a program that is generally in the form of a computer-usable medium having computer readable instructions stored thereon for execution by a processor. It is well known, in the art, that a processor in response to software or firmware instructions can perform such processes as discussed above. The program for accomplishing the aforementioned can be located in an operations system of a computer, a graphics program, a word processor program, a print driver or any other location where it can be utilized to achieve dual printing on a single transparency. Examples of the computer-usable medium include imaging firmware, random access memory (RAM), read only memory (ROM), static random access memory (SRAM), electrically eraseable programmable read only memory (EEPROM), mag media, optical media, etc.

Moreover, although the above described illustrations of the present invention deal with a composite image comprising two separate images, it will be understood in the art that the teachings of the present invention may also apply to the combining of more than two images to form the composite image on a transparency and that the present invention is not limited to a composite image that combines only two images. The only restriction is that the slots and blocking strips of the mask, used on the transparency to project one of the images, have to be positioned within a certain predefined distance of each other to take advantage of an individuals natural ability to filter out the blocking strips while being able to perceive one of the images being projected through the slots. Accordingly, the lines that make up the composite image have to be positioned to match the mask. That is, the lines that make up one of the images have to align with the slots of the mask while the remaining lines that make up the remaining images have to align with the blocking strips of the mask.

Although specific embodiments have been illustrated and described herein, it will be appreciated by those of ordinary skill in the art that any arrangement, which is calculated to achieve the same purpose, may be substituted for the specific embodiment shown. In particular, although, the present invention has generally been described as using only two images, it will be understood in the art, that the above-described embodiments could also be applied to more than two images without departing from the spirit of the present invention. This application is intended to cover any adaptations or variations of the present invention. Therefore, it is manifestly intended that this invention be limited only by the claims and the equivalents thereof.

What is claimed is:

1. A method of using a transparency comprising:
generating a composite image containing two or more indicia, the composite image includes a plurality of lines, wherein each line contains a portion of one of the two or more indicia, further wherein the plurality of lines are arranged so that at least some of the lines that make up each one of the two or more indicia are interposed between lines that make up the other of the two or more indicia; and
placing the lines that form the composite image on a transparency.

2. The method of claim 1, wherein the two or more indicia are selected from the group consisting of, text, symbols and graphical images.

3. The method of claim 1, wherein the lines of the transparency are orientated in a manner selected from a group consisting of, horizontal to a bottom edge of the transparency, vertical to a bottom edge of the transparency and diagonal to a bottom edge of the transparency.

4. The method of claim 1, wherein the lines are curved.

5. The method of claim 1, further comprising:
positioning a mask having a plurality of viewing slots over the transparency so that the lines containing the portions that make up a selected one of the two or more indicia are aligned with the plurality of slots.

6. The method of claim 5, further comprising:
illuminating the transparency to display the selected one of the two or more indicia that is aligned with the plurality of viewing slots.

7. The method of claim 1, wherein the two or more indicia comprise a first and second indicia, wherein generating the composite image further comprises:
arranging lines making up the first indicia to be every other line of the composite image; and
arranging lines making up the second indicia to be every other line of the composite image so that the lines of the composite image alternate between lines that make up the first indicia and lines that make up the second indicia.

8. The method of claim 7, further comprising:
positioning a mask having a plurality of viewing slots over the transparency, wherein the slots of the mask are positioned so that every other line of the transparency aligns with an associated slot.

9. A mask for use in projecting a selected image from a transparency having a composite image, wherein the composite image comprises the selected image and at least one additional image with lines of the selected image being interposed between lines of the additional images, the mask comprising:
a sheet of material having a plurality of slots and blocking strips, the blocking strips are positioned between the slots in an alternate fashion.

10. The transparency mask of claim 9, wherein when the mask is placed over a transparency it can be selectively positioned so that portions that make up the selected image are aligned with associated slots and portions that make up the at least one additional image are covered by an associated blocking strip.

11. The transparency mask of claim 9, wherein the plurality of slots and blocking strips are formed to conform to the orientation and shape of the lines on the transparency.

12. The transparency mask of claim 9, wherein the selected image and the at least one additional image comprise a first and second image, further wherein when the mask is placed over a transparency it can be selectively positioned so that every other line of the transparency is aligned with an associated slot and every one of the remaining lines are covered by an associated blocking strip.

13. The transparency mask of claim 12, wherein the lines of the transparency are aligned with respective slots and blocking strips of the mask by aligning a mask end edge with a transparency end edge.

14. A computer-usable medium having computer-readable instructions stored thereon for execution by a processor to perform a method comprising:
receiving an instruction to print two or more indicia as a composite image; and
generating the composite image, wherein each of the two or more indicia is separated into portions and all of the portions that comprise the two or more indicia are positioned in an alternating fashion in the composite image.

15. The computer-usable medium of claim 14, wherein the method further comprises:
receiving instructions selecting the two or more indicia to print as the composite image.

16. The computer-usable medium of claim 14, wherein the two or more indicia comprise a first and second indicia, wherein the method further comprises:
printing the portions of the first indicia on every other line of a transparency starting with a first line; and
printing the portions of the second indicia on every other line of the transparency starting with a second line, wherein the lines of the transparency alternate between the first and second indicia.

17. The computer-usable medium of claim 16, wherein the method further comprises:
printing a mask having transparent slots and blocking strips, wherein the transparent slots and blocking strips are positioned on the mask so that every other line matches up with an associated blocking strip of the mask and the other lines align with the slots of the mask when the transparency is selectively positioned adjacent the mask.

18. The computer-usable medium of claim 16, wherein the method further comprises:
receiving an instruction on an orientation of blocking strips and slots of a mask; and
computing an orientation of the lines to be printed on the transparency so that every other line matches up with an associated blocking strip of the mask and the other lines align with the slots of the mask when the transparency is selectively positioned adjacent the mask.

19. The computer-usable medium of claim 16, wherein the method further comprises:
receiving an instruction defining a positioning of blocking strips and slots of a mask; and
computing a position of every other line of the transparency so that every other line matches up with an associated blocking strip of the mask and the other lines align with the slots when the transparency is selectively positioned adjacent the mask.

20. The computer-usable medium of claim 16, wherein the method further comprises:
receiving an instruction defining a shape of locking strips and slots of a mask; and
computing a shape of lines to be printed on the transparency so that every other line matches up with an associated blocking strip of the mask and the other lines align with the slots of the mask when the transparency is selectively positioned adjacent the mask.
